(19) United States
(12) Patent Application Publication
(10) Pub. No.: US 2018/0276112 A1
(43) Pub. Date: Sep. 27, 2018

(54) BALANCING MEMORY PRESSURE ACROSS SYSTEMS

(71) Applicant: International Business Machines Corporation, Armonk, NY (US)

(72) Inventor: Kirk J. Krauss, San Jose, CA (US)

(73) Assignee: International Business Machines Corporation

(21) Appl. No.: 15/469,757

(22) Filed: Mar. 27, 2017

(51) Int. Cl. G06F 12/02; G06F 12/08; G06F 9/455

(52) U.S. Cl. CPC G06F 12/023; G06F 12/08; G06F 9/45558; G06F 2212/1044; G06F 2009/45583; G06F 2212/656; G06F 2212/657; G06F 2009/4557; G06F 2212/151

(57) ABSTRACT

A memory balancing method, system, and computer program product include determining page fault rate metrics for guest operating systems. Embodiments can use these metrics to determine total guest page allocations among a set of virtual machines, virtual machine placement, and/or candidates for host-to-host migration of virtual machines to explain a means of determining page fault rates using a paravirtual memory manager component for each guest.

### BACKGROUND

The present invention relates generally to a memory balancing method for application software, and more particularly, but not by way of limitation, to a system, method, and computer program product for determining page fault rate metrics for guest operating systems and for using these or related metrics to determine total guest page allocations among a set of virtual machines, and/or virtual machine placement, and/or candidates for host-to-host migration of virtual machines.

Memory overcommitment in a hosted virtual machine environment can “greatly reduce performance” either for one or more individual guest virtual machine(s), or for the host together with them. When a guest is thrashing because of memory pressure, this may be alleviated if the host can provide more virtual memory to the guest. When the host is thrashing because of guests overcommitting the host's virtual memory, this may be alleviated if the host can recover virtual memory from the guest(s), or if a guest can be migrated to another host.

Paravirtualization allows for some component of a guest to be aware of some aspects of the underlying host. The VMware ESX Server and XenServer packages provide paravirtual memory management components that provide for a “balloon” of guest virtual memory that expands, when the host is overloaded, to pressure a guest to swap pages to its virtual disk. The balloon component is normally implemented as a type of device driver that responds to commands from the host to commit or decommit virtual memory in the guest. The guest operating system swaps out the guest's own pages to accommodate the balloon as it expands, and it reloads pages as the balloon shrinks.

The benefit of this ballooning mechanism is in its simplicity: when the host is beginning to overload because of memory pressure, it does nothing more than make one or more of the guests' balloons expand. A guest operating system, with no special programming for virtual machine environments, makes the choice of which of the guest's pages to swap out, assuming that the balloon's expansion leads to memory overcommitment by the guest. But the ballooning approach has many drawbacks.

One drawback is that it is a large-hammer approach in that no consideration is given to how much each particular guest, or even some unrelated process running on the host, is dragging down the host's performance. A guest that is actively working with its committed virtual memory will be forced to swap out much-needed pages, whether or not another guest might have swapped out inactive pages instead. Thus, in typical ballooning scenarios, some guests will suffer unnecessarily because of other guests or processes that may not have suffered at all.

Another drawback is that the balloon is not grown or shrunk without some performance overhead of its own. A directive to grow or shrink a balloon may be transferred quickly from host to guest. However, the guest has to commit or decommit virtual memory to handle the directive. If several guests get the directive at once, then the overhead is cumulative for the system as a whole. Also, the balloon's virtual memory will occupy some physical memory space, albeit a small one thanks to page deduplication strategies which may nevertheless require quite a few cycles to run.

There is a need in the art for targeting of guests that can best afford to give up some committed virtual memory. Another need in the art is for the balancing of the host's virtual memory needs against those of each guest. Another improvement would be the optimizing of virtual memory resources between guest(s) and host in a memory overcommitment situation. Yet another need in the art is for the elimination of such virtual memory overhead as may be imposed by the ballooning approach.

### SUMMARY

In an exemplary embodiment, the present invention can provide a computer-implemented memory balancing method, the method including determining, by a processor, that virtual memory comprising at least two operating systems is overcommitted, comparing, by the processor, metric data comprising detected page fault rates of the at least two operating systems, and in response to the comparing, providing, by the processor, to one of the at least two operating systems, an indication to modify a number of loaded virtual memory pages. One or more other exemplary embodiments include a computer program product and a system, based on the method described above.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways that should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a memory balancing method 100 according to an embodiment of the present invention;

FIG. 2 exemplarily depicts balancing page fault rates for guests on a node;

FIG. 3 exemplarily depicts balancing page fault rates across nodes;

FIG. 4 depicts a cloud computing node 10 according to an embodiment of the present invention;

FIG. 5 depicts a cloud computing environment 50 according to an embodiment of the present invention; and

FIG. 6 depicts abstraction model lavers according to an embodiment of the present invention.

### DETAILED DESCRIPTION

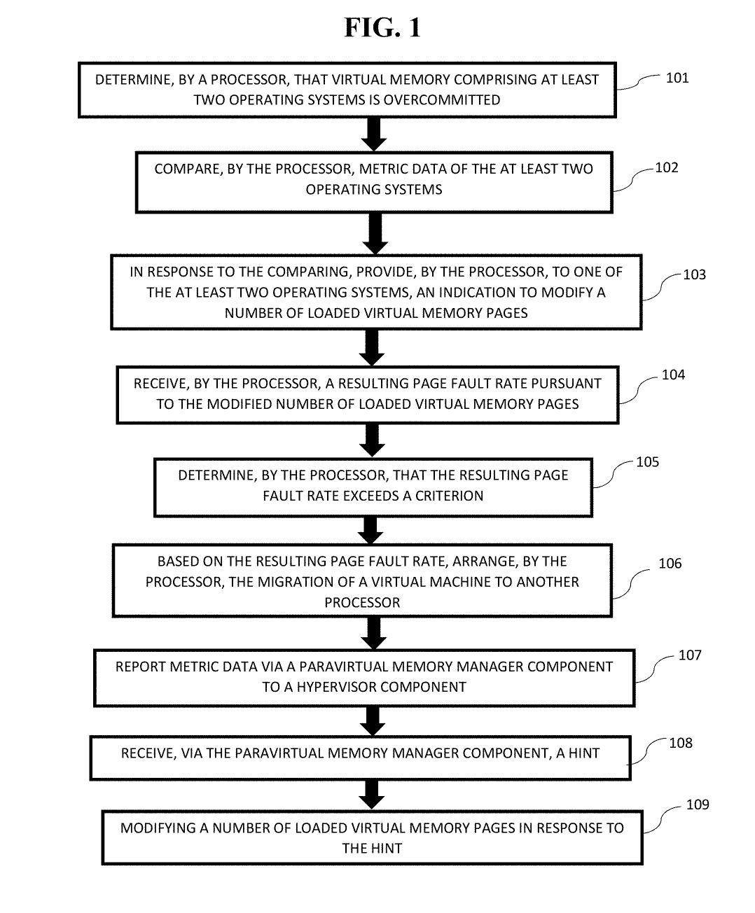

The invention will now be described with reference to FIGS. 1-6, in which like reference numerals refer to like parts throughout. It is emphasized that, according to common practice, the various features of the drawings are not necessarily to scale. On the contrary, the dimensions of the various features can be arbitrarily expanded or reduced for clarity.

By way of introduction of the example depicted in FIG. 1, an embodiment of a memory balancing method 100 according to the present invention can include various steps for balancing guests' virtual memory by comparing metrics of any kind from guest to guest. In some embodiments, host virtual memory usage metrics also can be compared with memory usage metrics for one or more guests.

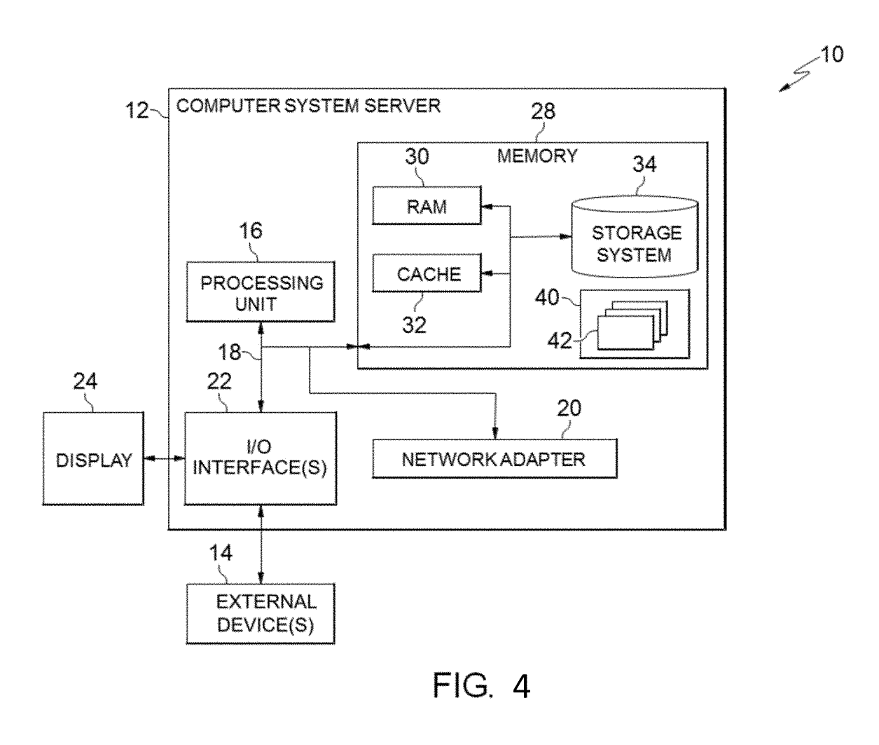

By way of introduction of the example depicted in FIG. 4, one or more computers of a computer system 12 according to an embodiment of the present invention can include a memory 28 having instructions stored in a storage system to perform the steps of FIG. 1. A host system can comprise physical components of computer system 12. One or more guest systems can each comprise hardware-virtualized components similar to the physical components of the host system. The one or more guest systems can rely on the physical components of the host system to perform computation for any purpose germane to a hardware-virtualized system, including paravirtualized aspects as needed to enable the methods and systems for carrying out the several purposes of the present invention.

With reference generally to the embodiments of the invention, when memory pressure is affecting, or apt to affect, performance, a paravirtualized memory manager, running on a guest operating system, sends metric data to a hypervisor. A hypervisor, also known as a virtual machine manager or monitor, is a component typically operable on a physical host machine. Conventionally, the hypervisor serves to deploy guest virtual machines and to allocate and manage the resources used by those guest systems. In embodiments the invention, based on the metric data, and possibly based on metric data from other guests or the host itself, the hypervisor decides whether to (1) indicate to the paravirtualized memory manager to swap paged-in memory out to its virtual disk storage; (2) indicate to the paravirtualized memory manager to swap paged-out memory back in from storage; (3) migrate the guest virtual machine to another node; or (4) make no changes to guest allocations. In some embodiments, the hypervisor, or a memory management component for a distributed or cloud computing environment, also can choose a host system on which to deploy a guest system, based on a comparison of the metric data across multiple hosts.

Because the embodiments of the invention are based on metrics, and because the embodiments exchange information and indicators directly between guest and host, they can serve on an ongoing basis to optimize the virtual memory footprints of all guests, and the host too, to best manage memory overcommitment system-wide. The invention also can scale to provide memory overcommitment balance across nodes.

That is, the invention can provide a paravirtual component of a guest operating system's memory manager that collects metric data including, but not limited to, a page fault count or rate over a recent interval such as the last several seconds, a committed virtual memory page count, and (in some implementations) further applicable data such as a count or percentage of committed pages that have been accessed over a recent interval. The paravirtual component provides this data to the underlying hypervisor or to a memory management component running on the host system. It provides this data either on demand, or according to a schedule, or in response to a performance metric indicative of a low-memory condition. In some embodiments, a similar component, running on the host, can provide similar metric data for the host itself to the hypervisor or memory management component.

Page fault rates can indicate situations in which system performance is affected or apt to be affected. A page fault is an exception or interrupt that occurs when a process attempts to access virtual memory that is not mapped to physical memory. The page fault is typically handled by loading a page from disk into memory. If there is not sufficient physical memory available to store the loaded page, then another virtual memory page is typically swapped out to disk to accommodate the loaded page. In a virtualized environment, a guest is typically assigned a certain amount of hardware-virtualized memory that appears to the guest operating system as physical memory. Embodiments of the invention can identify situations in which the performance of a guest is affected by page faults relatively frequently, with respect to other guests running on either the same host or, in embodiments operable on a distributed or cloud computing environment, a group of hosts. Embodiments also can identify situations in which a guest, though it may have considerable committed memory in use, is affected by page faults only relatively infrequently. Embodiments additionally can identify situations in which a guest is assigned hardware-virtualized memory that it is not using. Further, embodiments can compare guest memory utilization and page fault rates over time and thus can identify trends according to which page fault rates are apt to be affected. Some embodiments can identify these situations and trends for both the host itself and any guests it is hosting.

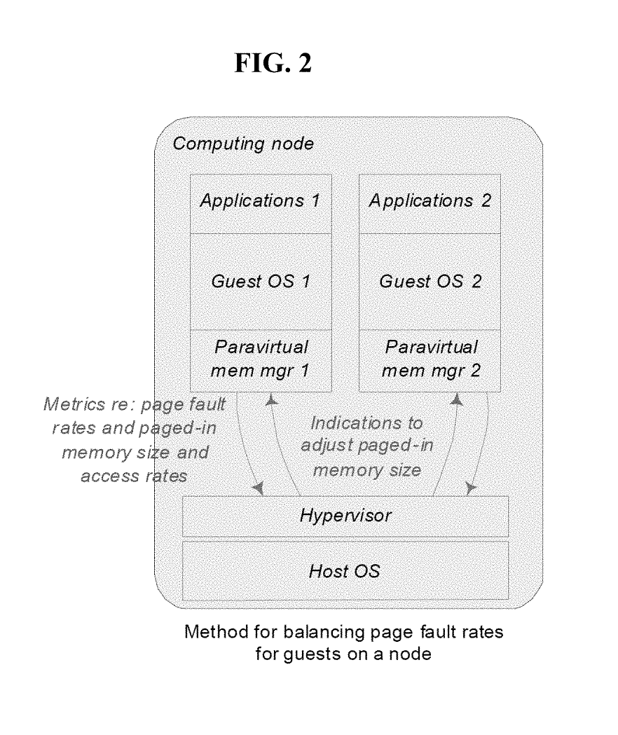

With reference to FIG. 2, the hypervisor or host memory management component may detect a memory overcommitment condition where page faults are affecting, or apt to affect, system performance. It can rely on the metrics such as page fault data from one or more guests to choose a course of action, such as one of (1) if a guest has a relatively large committed page count and a relatively low page fault rate (e.g. lower than that of the host operating system) then the host can send the guest a hint or directive to swap out pages to its virtual disk; (2) if a guest has a relatively high page fault rate (e.g. higher than that of the host operating system) then the host may attempt to provide more virtual memory to the guest; and (3) if all guests have relatively high, or increasing, page fault rates, then the host may attempt to migrate a selected guest to a different host. The selected guest may be the guest with the highest page fault rate per recently accessed page. The decision to migrate between hosts may involve a check for expected memory overcommitment on the destination host. In an embodiment in which a guest system is deployed on a distributed or cloud computing environment, the hypervisor or host memory management component can choose to deploy the guest system onto a host system on which page faults are not affecting, or apt to affect, system performance. In some embodiments where host metric data is collected and analyzed in addition to guest metric data, the host may attempt to modify guest virtual memory allocations or migrate a guest, based on the host's own metrics in addition to, or in lieu of, the guests' metrics.

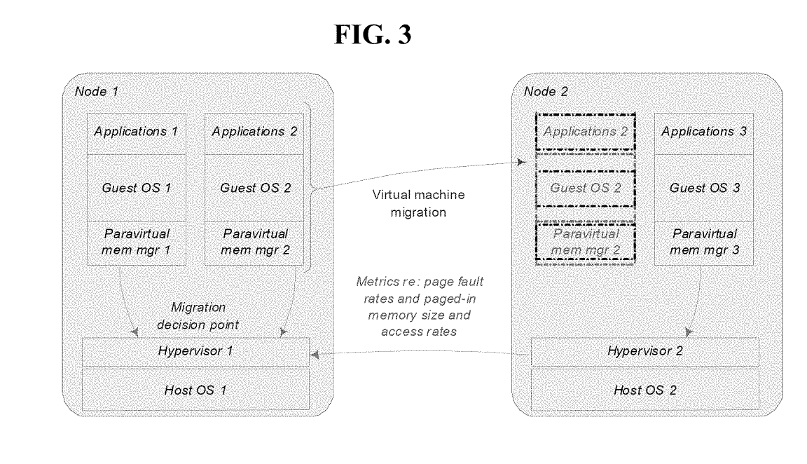

With reference to FIG. 3, the invention can be implemented to span multiple hosts by comparing page fault rates and committed page counts spanning those hosts. Hypervisors or other memory management components within a cluster of nodes can compare these metrics. A node with some of the highest page fault rate metrics per guest can determine whether to migrate a virtual machine to a node with some of the lowest page fault rates per guest. A node with a relatively low page fault rate per guest may serve to host migrated or newly deployed guests. That way, a set of hosts may balance their collective memory overcommitments in terms of page faults per committed or active page per guest. In some embodiments, the invention can be used in conjunction with other techniques for selecting a host on which to migrate or deploy a guest, such as fitting predefined virtual machine resource requirements to host resource availability according to a placement heuristic, a compatibility check, or other conventional techniques familiar to those skilled in the art. Embodiments of the invention can enhance the conventional techniques by allowing for resource overcommitment in the event that page fault metrics reveal that an overcommitment of resources, in an amount necessary for deployment of a guest, is not apt to affect system performance. In other embodiments, the invention can be used on its own for host selection.

Now, with reference to FIG. 1, the steps of the method 100 can determine page fault rate metrics for guest operating systems. Embodiments can use these metrics to determine total guest page allocations among a set of virtual machines, virtual machine placement, and/or candidates for host-to-host migration of virtual machines while determining page fault rates using a paravirtual memory manager component for each guest.

In step 101, it is determined, by a processor, that virtual memory comprising at least two operating systems is overcommitted;

In step 102, metric data is compared, by the processor, the metric data comprising detected page fault rates of the at least two operating systems; and

In step 103, in response to the comparing, an indication is provided, by the processor, to one of the at least two operating systems, to modify a number of loaded virtual memory pages.

In step 104, a resulting page fault rate is received, by the processor, pursuant to the modified number of loaded virtual memory pages.

In step 105, it is determined, by the processor, that the resulting page fault rate exceeds a criterion.

In step 106, based on the resulting page fault rate, it is arranged, by the processor, that a virtual machine is migrated to another processor.

In step 107, metric data is reported via a paravirtual memory manager component to a hypervisor component.

In step 108, a hint is received via the paravirtual memory manager component.

In step 109, a number of loaded virtual memory pages is modified in response to the hint.

In some embodiments, the above steps with reference to FIG. 1 can serve to determine page fault rate metrics for a guest operating system in comparison to page fault rate metrics for the underlying host operating system and to facilitate balancing memory pressure between the guest and host. In some embodiments, these steps can serve to determine page fault rate metrics for guest operating systems running on a common underlying host and to facilitate balancing memory pressure among the guests running on that host. In some embodiments, these steps can serve to determine page fault rate metrics for a guest running on one host with respect to a guest running on another host and to facilitate balancing memory pressure among the guests running on the multiple hosts.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of distributed computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 4, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 4, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

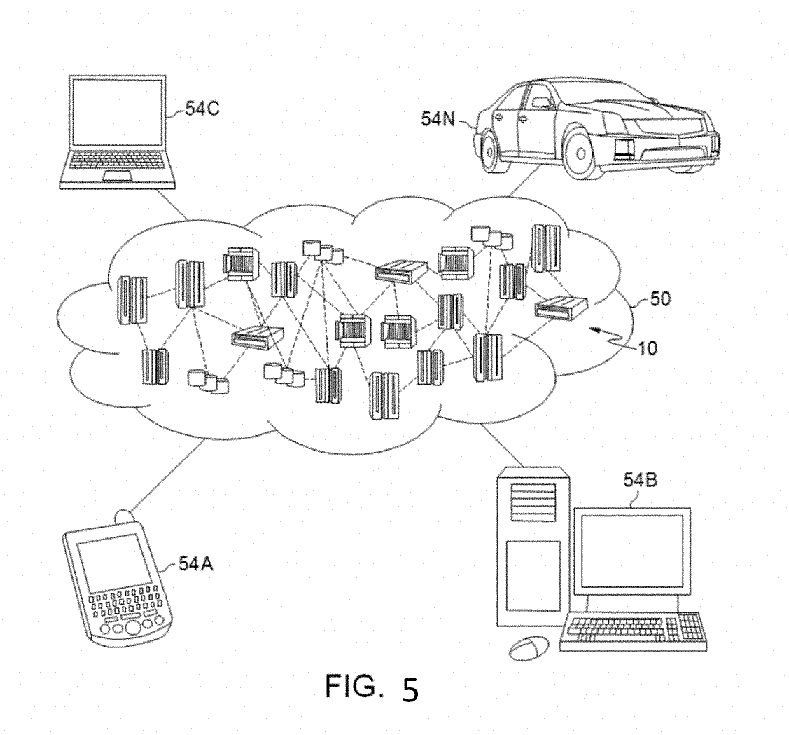

Referring now to FIG. 5, illustrative cloud computing environment 50 is depicted. As shown, cloud computing environment 50 comprises one or more cloud computing nodes 10 with which local computing circuits used by cloud consumers, such as, for example, personal digital assistant (PIM) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 5 are intended to be illustrative only and that computing nodes 10 and cloud computing environment 50 can communicate with any type of computerized circuit over any type of network and/or network addressable connection (e.g., using a web browser).

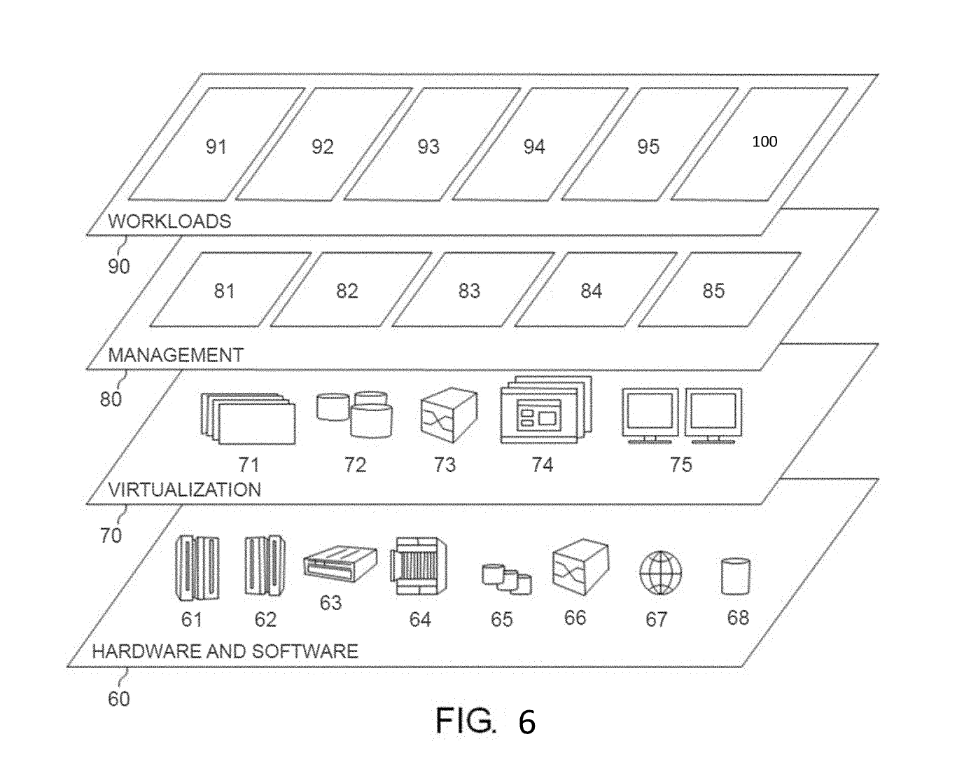

Referring now to FIG. 6, an exemplary set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 50 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and memory balancing method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be: for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), a Storage Area Network (SAN), a Network Attached Storage (NAS) device, a Redundant Array of Independent Discs (RAID), an erasable programmable read-only memory (EPROM or Flash memory), a static random access memory (SRAM) a portable compact disc read-only memory (CD-ROM), a digital versatile disk (DVD), a memory stick, a USB “thumb” drive, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and, or edge servers. A network adapter card or network interface in each computing/processing, device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry; field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or re executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented memory balancing method, the method comprising:
determining, by a processor, that a virtual memory comprising at least two operating systems is overcommitted;
comparing, by the processor, metric data of the at least two operating systems; and
in response to the comparing, providing, by the processor, to one of the at least two operating systems, an indication to modify a number of loaded virtual memory pages.

2. The computer-implemented method of claim 1, further comprising:
receiving, by the processor, a resulting page fault rate pursuant to the modified number of loaded virtual memory pages;
determining, by the processor, that the resulting page fault rate exceeds a criterion; and
based on the resulting page fault rate, arranging, by the processor, a migration of a virtual machine to another processor.

3. The computer-implemented method of claim 1, further comprising:
reporting metric data via a paravirtual memory manager component to a hypervisor component;
receiving, via the paravirtual memory manager component, a hint; and
modifying the number of loaded virtual memory pages in response to the hint.

4. The computer-implemented method of claim 3, where the metric data comprises one or more of a page fault rate and a committed page count or metric.

5. The computer-implemented method of claim 4, where the hint comprises an indication for an operating system to swap loaded virtual memory pages from its address space to a virtual disk.

6. The computer-implemented method of claim 4, where the hint comprises an indication for an operating system to swap virtual memory pages from a virtual disk into its address space.

7. The computer-implemented method of claim 4, where the hint is determined based on a comparison of page fault rates and committed page counts among a host machine's operating system and one or more virtual machine operating systems.

8. The computer-implemented method of claim 7, where the hint is received by a virtual machine operating system that has reported a smaller number of page faults per committed page than other machines manageable by the hypervisor component.

9. The computer-implemented method of claim 8, where the other machines manageable by the hypervisor component include the machine on which the hypervisor component executes.

10. The computer-implemented method of claim 1, where each of the page fault rates comprises a count of page faults over a time interval.

11. The computer-implemented method of claim 1, wherein the metric data comprises at least one of:
a page fault count over a recent interval;
a page fault rate over the recent interval;
a committed virtual memory page count; and
a count or percentage of committed pages that have been accessed over the recent interval.

12. A computer program product for memory balancing, the computer program product comprising a computer readable storage medium having program instructions embodied therewith, the program instructions executable by a computer to cause the computer to perform:
determining, by a processor, that a virtual memory comprising at least two operating systems is overcommitted;
comparing, by the processor, metric data of the at least two operating systems; and
in response to the comparing, providing, by the processor, to one of the at least two operating systems, an indication to modify a number of loaded virtual memory pages.

13. The computer program product of claim 12, further comprising:
receiving, by the processor, a resulting page fault rate pursuant to the modified number of loaded virtual memory pages;
determining, by the processor, that the resulting page fault rate exceeds a criterion; and
based on the resulting page fault rate, arranging, by the processor, a migration of a virtual machine to another processor.

14. The computer program product of claim 12, further comprising:
reporting metric data via a paravirtual memory manager component to a hypervisor component;
receiving, via the paravirtual memory manager component, a hint; and
modifying the number of loaded virtual memory pages in response to the hint.

15. The computer program product of claim 14, where the metric data comprises one or more of a page fault rate and a committed page count or metric.

16. The computer program product of claim 15, where the hint comprises an indication for an operating system to swap loaded virtual memory pages from its address space to a virtual disk.

17. The computer program product of claim 15, where the hint comprises an indication for an operating system to swap virtual memory pages from a virtual disk into its address space,

18. A memory balancing system, said system comprising:
a processor; and
a memory, the memory storing instructions to cause the processor to perform:
determining, by a processor, that a virtual memory comprising at least two operating systems is overcommitted;
comparing, by the processor, metric data of the at least two operating systems; and
in response to the comparing, providing, by the processor, to one of the at least two operating systems, an indication to modify a number of loaded virtual memory pages.

19. The system of claim 18, wherein the memory further stores instructions to cause the processor to perform:
receiving, by the processor, a resulting page fault rate pursuant to the modified number of loaded virtual memory pages;
determining, by the processor, that the resulting page fault rate exceeds a criterion; and
based on the resulting page fault rate, arranging, by the processor, the migration of a virtual machine to another processor.

20. The system of claim 18, embodied in a cloud computing environment.
